(19) United States
(12) Patent Application Publication
(10) Pub. No.: US 2013/0181461 A1
(43) Pub. Date: Jul. 18, 2013

(54) POWER PLANT UNIT

(71) Applicant: GE Jenbacher GmbH & Co OG, Jenbach (AT)

(72) Inventor: Friedrich GRUBER, Hippach (AT)

(73) Assignee: GE JENBACHER GMBH & CO OG, Jenbach (AT)

(21) Appl. No.: 13/783,887

(22) Filed: Mar. 4, 2013

Related U.S. Application Data
(63) Continuation of application No. PCT/AT2011/000360, filed on Sep. 2, 2011.

(30) Foreign Application Priority Data
Sep. 6, 2010 (AT) A 1481/2010

(51) Int. Cl. H02K 7/18; H02P 9/02

(52) U.S. Cl. CPC H02K 7/1815; H02P 9/02
USPC 290/4 A

(57) ABSTRACT

The invention relates to a power plant unit (1) for generating electrical power, comprising at least a first electric generator (2) which can be driven by a gas turbine (3), at least a second electric generator (4) which can be driven by a reciprocating piston engine (5). According to the invention, the at least one first and the at least second electric generator (2, 4) feed electrical power into a common network (6), wherein a section switch (7) is provided by which the common network (6) can be electrically connected to an electrical consumer (8).

The present invention relates to a power plant unit for generating electrical power, a power plant having at least one power plant unit of this kind and a method of operating a power plant unit or power plant of this kind.

A wide variety of technologies and methods are used to generate electricity in power plant technology. Thermal power plants, which are as a rule operated with fossil fuels, account for a relatively large proportion here. Key representatives are coal-fired power plants, heavy oil or diesel and gas-fired power plants. Gas-fired power plants have taken an increasing share of the market in recent years for a variety of reasons and it is expected that they will continue to grow in importance in the future.

In the case of gas-fired power plants, the main representatives are gas turbine plants and, to a significantly increasing extent, combined cycle power plants (CCPPs). Gas engines are widely used for relatively small output ranges.

At up to approx. 60%, CCPPs have the highest efficiencies that are currently achieved with thermal power plants. For cost reasons, this technology is only used cost-effectively for a power plant output>300 MW.

Specifically, the costs of installing and operating gas turbine plants are very low, but the efficiencies achieved range between only 35% and 40%. Gas turbine plants are predominantly used to cover consumption peaks and to generate balancing energy.

The main problem areas with gas turbine plants and CCPPs include the relatively poor partial-load efficiency and the very unsatisfactory control behavior under load (in particular applied load behavior).

At up to approx. 100 MW plant output with efficiencies of up to 48%, reciprocating piston engine plants are very cost-effective. In addition to this very high full load efficiency in relation to the output, gas engines also have very good efficiencies at partial load and relatively good control behavior under load that is comparable to diesel engines.

The disadvantages of gas engine plants are the relatively high specific costs of operation, service and maintenance and the significantly higher pollutant emissions compared with the gas turbine.

Each of these gas-fired power plant technologies has specific advantages and disadvantages, with the result that the most suitable variant depends on the particular requirements and boundary conditions.

Power plant units the generators of which are driven by reciprocating piston engines have the disadvantage that, in the event of a sudden short interruption of the consumer grid (short interruptions), a relatively rapid change may occur in the frequency of the generator set compared with that of the public grid and thus an incompatible phase shift between generator and grid may occur when the grid voltage is recovered. Such events can have a damaging effect on components of the generator set or may lead to a failure.

The object of the invention is to provide a cost-effective power plant unit in which only frequency deviations within the permissible limits occur even in the event of short interruptions of the power take-up by an electricity consumer, for example a public electricity grid.

This object is achieved by a power plant unit with the features of claim 1.

According to the invention it is thus provided that a reciprocating piston engine, in particular a gas engine, and a gas turbine in each case drive an electric generator the electrical power of which is fed into a common grid. This common grid can be connected to an electricity consumer, for example the public grid, by a section switch. If the section switch is opened or if the electricity consumer, for example the public grid, is de-energized, the frequency of the common grid is essentially determined by the behavior of the gas turbine, which can be controlled in a very stable manner due to the inertia of the gas turbine rotors. It is thus possible to keep the frequency of the electric voltage in the common grid within the permissible limits in the event of short interruptions to the grid.

Further advantageous embodiments of the invention are defined in the dependent claims.

It is conceivable on the one hand for precisely one gas turbine and precisely one reciprocating piston engine, which each drive precisely one generator, to be provided for each power plant unit. Variations are, however, also conceivable. For example, it can be that at least two reciprocating piston engines, which each drive a generator of their own, are provided for each gas turbine.

It is sometimes assumed below, by way of example, that a reciprocating piston engine is in the form of a gas engine.

The invention permits a gas turbine and a gas engine to be integrated in a single, self-contained power plant unit in such a way that maximum synergy of both assemblies can be achieved and thus that costs can be reduced and performance increased, that is the operating characteristics of the entire plant can be improved.

For reasons of compatibility of the pollutant emissions of gas engine and gas turbine, it is preferably provided that suitable technologies for reducing emissions are used in the gas engine. This is done, for example, either by using a combination of oxidation catalytic converter and SCR catalytic converter or by reforming the fuel for the gas engine and using an extreme lean operation process. Additional equipment that is arranged within the power plant unit is required for both emission reduction methods.

Approx. 80% of the full load output of the power plant unit is preferably provided by the gas turbine assembly. This has the advantage that the turbine is switched off in the event of load requirements of <20% and the electrical power can be generated with the very high engine efficiency (in the full load range of the reciprocating piston engine).

The concept of the power plant unit is above all designed to form modular subunits for a power plant complex with an output capacity of up to approx. 400 MW. With power plant units formed from such subunits, assembly outputs can, with regard to the total output in fine gradations, be added or removed while the assemblies remaining in operation run at full load.

### EXAMPLE

Standardized machine hall or building for the following power plant components:
gas turbine generator set: output range of 30-70 MW
gas engine generator set: output range of 5-20 MW
H2 reforming device for the propellant of the gas engine or exhaust aftertreatment device
with a combination of oxidation catalytic converter+SCR catalytic converter
control, regulating and monitoring device for all power plant parts and components
propellant control and safety system for gas engine and gas turbine
auxiliaries for start-up and operation of both generator assemblies
common air intake filter for both generator assemblies
engine room ventilation
heat exchanger
pipeline routings

The following are arranged, for example, on the roof of the building for the machine hall:
dry cooler or ambient air heat exchanger for cooling engine coolant, engine oil, charge air
and possibly intermediate cooling of the air for the compressors of the gas turbine
intake air box with intake silencer
exhaust silencer with exhaust stack

It is furthermore advantageously provided that:
Gas engine and gas turbine use the same device for the intake, intake silencing and filtering of the combustion air
Gas engine and gas turbine use the same device for the exhaust silencing and the stack system
The engine room ventilation is designed for both the gas turbine and the gas engine
The control, regulating and safety functions for all components are performed by a common central processing unit
Gas engine assembly and gas turbine assembly have a common transformer for adapting the voltage to the consumer grid
Use of the cooling devices is shared by gas engine and gas turbine, depending on the existing temperature level
Use of the gas control and safety system is shared as far as possible by gas engine and gas turbine
Gas engine and gas turbine are fed by a common flushing air device with which the air and exhaust ducts (for safety reasons) can be flushed before start-up and after shutdown.

Possible specific operational management and functions of the integrated power plant unit:
The gas engine is operated over a longer period of time than the gas turbine for the following reasons:
The efficiency of the gas engine is approx. 48% and is thus substantially higher than that of the gas turbine (approx. 38%)
This difference increases significantly with partial load.
For partial-load requirements of the plant, the turbine is switched off below 20% of the turbine nominal load, with the result that a baseline plant output can be generated with very high efficiency.
For start-up of a gas turbine generator set, the engine already operating is used to activate the auxiliaries of the gas turbine, in particular the starter device.
The waste heat from the engine and that from the turbine are brought together at the respective levels and released together into the environment or are fed to the various consumer networks. For example, the coolant heat of the engine, the oil heat of the engine and turbine, the heat from the high-temperature stages of the air heat exchanger of engine and gas turbine, and the heat from the (common) waste heat boiler can be fed to a heat consumer for heating purposes at a temperature level of approx. 90° C.
However, the energy of the exhaust gas from gas engine and gas turbine can, for example, also be fed to a common steam process for the further generation of electrical energy (via an Organic Rankine Cycle, for example).
In the event of application involving rapid load applications or load impacts, the engine is operated at low load before load impact with the result that the design load capacity of the gas engine, which is significantly better in comparison with the gas turbine, can be fully utilized.

An advantageous aspect of the invention is that the specific investment costs can be reduced by the gas turbine and gas engine sharing the use of the devices and components of the power plant unit to the maximum extent possible.

Furthermore, the invention enables standardized power plant units to be built that can be combined to form power plant complexes or power plants and enable very low specific production costs due to high manufacturing volumes and a high degree of prefabrication.

Furthermore, advantages also result from the fact that less heat is produced in comparison with large-scale power plants and there are therefore more possibilities for disposing of the waste heat in suitable consumer networks. This makes decentralization much more feasible.

The efficiency of an integrated combination of gas turbine and gas engine is approx. 2 percentage points higher over the entire load range than a pure gas turbine plant. The way in which partial-load operation is implemented, for example whether initially only the gas engine is operated at partial load or whether only the gas turbine or both systems simultaneously, has no impact on the efficiency of the plant. For example:
a) The plant output is reduced by reducing only the gas engine output, the gas turbine continues to operate at full load
b) The plant output is reduced by reducing only the gas turbine output, the gas engine continues to operate at full load
c) The plant output is reduced by reducing the output of gas engine and gas turbine to an equal extent.

Modern gas engines in principle have low pollutant emissions in the exhaust gas and are in this respect significantly more environmentally friendly than diesel engines.

However, the emissions from gas turbines are significantly lower still. In particular in the case of NOx and unburned hydrocarbons, the emissions from gas engines without corresponding exhaust aftertreatment are considerably higher than those from gas turbines.

The emission guidelines for gas turbine power plants are based on values that can be achieved with gas turbines, with the result that gas engine plants cannot usually be combined with turbine plants without corresponding emission reduction measures. To this end, a variety of methods are available: in addition to exhaust aftertreatment, for instance by oxidation and/or SCR catalytic converters, extreme leaning of the mixture and/or fuel pretreatments such as, for example, hydrogen reformation are used.

Further advantages and details of the invention are apparent from the figures and the associated description of the figures. There are shown in:

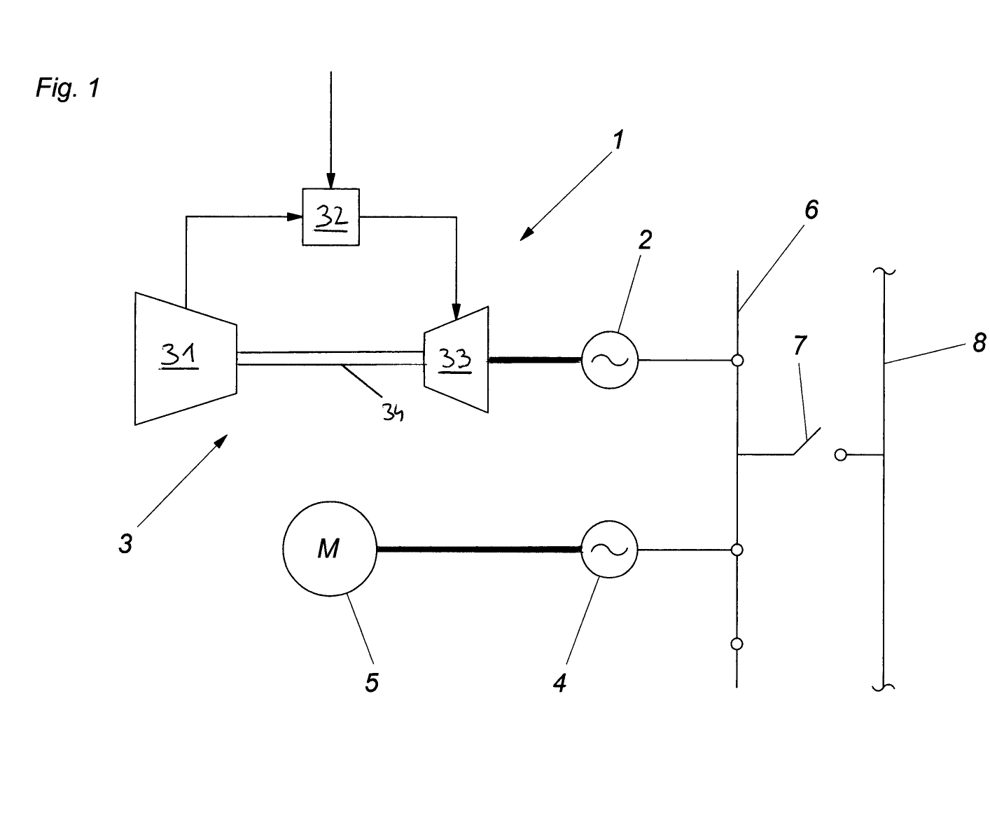

FIG. 1 a schematic view of a power plant unit according to the invention,

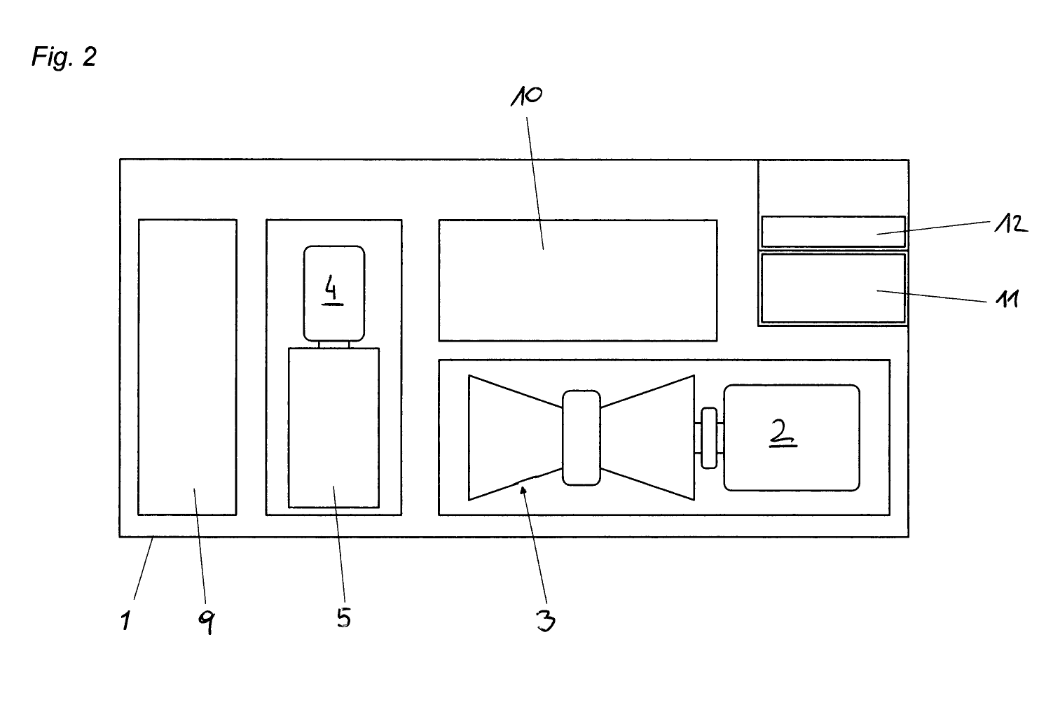

FIG. 2 a schematic layout view of an example of a spatial design of a power plant unit and

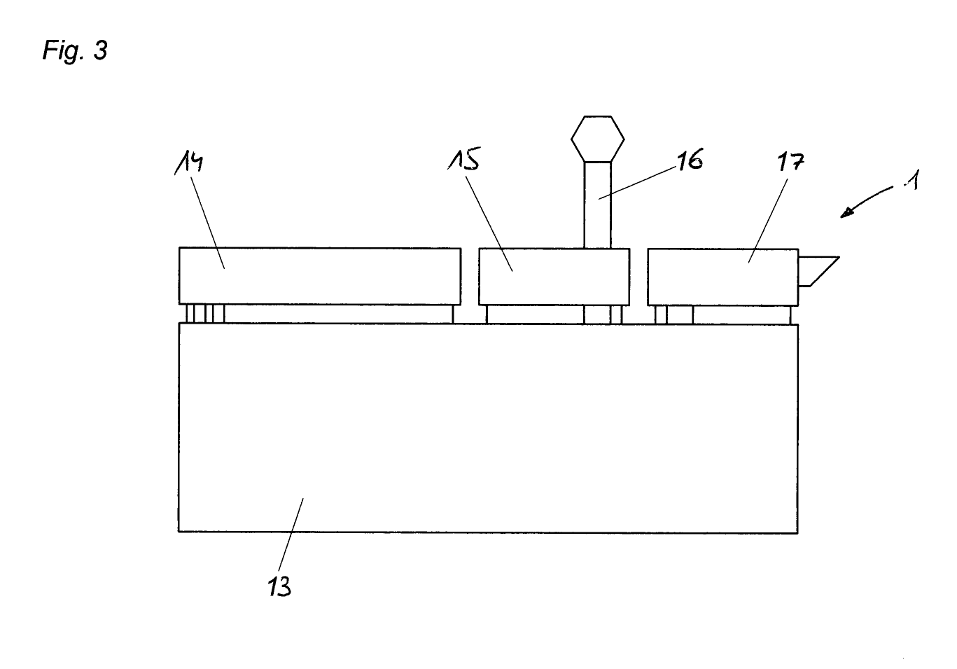

FIG. 3 a schematic side view, by way of example, of the spatial arrangement of individual power plant components on the outside and on the roof of a building for a power plant unit.

FIG. 1 shows a schematic view of the logical design of a power plant unit 1 according to the invention, consisting here of a reciprocating piston engine 5 and a gas turbine 3, which each drive an electric generator 4 and 2 respectively. The design of the gas turbine 3 (compression stage 31, combustion chamber 32 with gas supply, expansion stage 33, shaft 34) is shown only in schematic view since it corresponds to the state of the art.

Both generators 2, 4 feed their electrical power into a common grid 6, which can be electrically connected to an electricity consumer 8, which is shown here by way of example as a public grid, via a section switch 7.

FIG. 2 shows the layout of a basic arrangement of power plant elements within the power plant unit 1. Within the power plant unit 1 there are a reforming device or an exhaust aftertreatment device 9 for the propellant of the gas engine 5 and for the exhaust gas of the gas engine 5 respectively, the gas engine generator assembly 4,5, the gas turbine generator assembly 1,2, a platform for heat exchangers and auxiliaries 10, a power unit 11 and control and regulating cabinets 12.

FIG. 3 shows an outline view of the power plant unit 1. Above a machine building 13 there are a dry cooler unit 14, an exhaust silencer 15 with exhaust stack 16 and a silencer splitter 17 for the intake air.

1. A power plant unit for generating electrical power, Comprising:
at least one first electric generator configured to be driven by a gas turbine,
at least one second electric generator configured to be driven by a reciprocating piston engine,
wherein the at least one first and the at least one second electric generator feed electrical power into a common grid, wherein a section switch is provided to electrically connect the common grid to an electricity consumer.

2. The power plant unit according to claim 1, wherein the gas turbine is designed for an output range of from approximately 30 MW to approximately 70 MW.

3. The power plant unit according to claim 1, wherein the output of the reciprocating piston engine is approx. 15% to approx. 25% of the output of the gas turbine.

4. The power plant unit according to claim 1, wherein a common air intake device is provided for gas turbine and reciprocating piston engine.

5. The power plant unit according to claim 1, wherein a common exhaust silencer and common exhaust stack is or are provided for gas turbine and reciprocating piston engine.

6. The power plant unit according to claim 1, wherein the power plant unit is configured to feed waste heat of gas turbine and reciprocating piston engine to a common heat exchanger.

7. The power plant unit according t claim 1, wherein a common exhaust treatment device is provided for gas turbine and reciprocating piston engine.

8. The power plant unit according to claim 1, wherein the reciprocating piston engine has at least one charge-air inlet for precompressed charge air and the gas turbine has at least one compression stage, wherein the at least one charge-air inlet of the reciprocating piston engine is connected to an exit of the at least one compression stage via a charge-air line.

9. A power plant having at least two power plant units according to claim 1.

10. A method of operating a power plant unit according to Claim 1, wherein, in partial-load operation of the power plant unit, the gas turbine is switched off below approximately 20% of a standard load of the gas turbine and the reciprocating piston engine is operated alone.
